(19) United States
(12) Patent Application Publication
(10) Pub. No.: US 2005/0141465 A1
(43) Pub. Date: Jun. 30, 2005

(54) Wireless communication system for detecting location of the node

(75) Inventors: Takeshi Kato, Akishima (JP); Tsuyoshi Tamaki, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/017,178

(22) Filed: Dec. 21, 2004

(30) Foreign Application Priority Data
Dec. 24, 2003 (JP) 2003-426282

(51) Int. Cl. H04J 3/00

(52) U.S. Cl. 370/337

(57) ABSTRACT

Provided is a wireless communication system easily establishing a connection path in a sensor network collecting data from a number of sensor nodes. The wireless communication system comprises a base station communicating by a first wireless communication system, plural first nodes communicating by the first wireless communication system and a second wireless communication system, and plural second nodes communicating by the second wireless communication system. The first node transmits the number of hops in the first wireless communication system to the second node. The second node obtains a reception condition of at least one of a signal transmitted by the first node and a signal transmitted by the second node, and selects a upper stage node to connect based on the number of hops in the first wireless communication system, the number of hops in the second wireless communication system, and the obtained reception condition information.

### CLAIM OF PRIORITY

The present application claims priority from Japanese application P2003-426282 filed on Dec. 24, 2004, the content of which is hereby incorporated by reference into this application.

### BACKGROUND OF THE INVENTION

This invention relates to a wireless communication system having a network topology, and in particular, to a construction technology of an ad hoc network such as a sensor network and a location measurement technology of a sensor node.

In a ubiquitous computing society, mobile communication, a wireless LAN of companies and the general public, and a P2P network are combined, whereby a physical world and a virtual world are connected to each other. For a purpose of obtaining a context (action, environment), a sensor network develops. In the sensor network, an infra-network (intensive management) of a upper stage level may be mixed with a P2P network (ad hoc) on a terminal side to construct a complex network.

CHEE-YEE CHONG et al. “Sensor Networks: Evolution, Opportunities, and Challenges”, PROCESSINGS OF THE IEEE, Institute of Electrical and Electronics Engineers, August 2003, Vol. 91, No. 8 discloses the summary of such a sensor network.

### SUMMARY OF THE INVENTION

In order to evolve and grow a complex network such as a sensor network, a self-organized network structure enabling a dynamic organization of a network is required. In other words, a hub is important, for which a scale-free network is suitable instead of infrastructure-concentrated and random-distributed networks, and which has an adoptability with an intelligent node that preferentially selects a connection path.

Furthermore, a near-field wireless system (e.g., FSK, UWB, ZigBee, etc.) used in a sensor network has a short communication distance, so that it is difficult to place a sensor in a wide range. In other words, in those near-field wireless systems, it is necessary to monitor the output of a sensor in the vicinity thereof, and there is a constraint to the arrangement of a sensor and monitoring equipment.

Furthermore, when a sensor node can be placed in a wide range, it is difficult to know the position of the sensor node thus placed.

It is therefore an object of this invention to provide a wireless communication system capable of collecting data from a wide range and easily establishing a connection path in a sensor network collecting data from a number of sensor nodes.

According to an embodiment of this invention, a wireless communication system comprises a wireless base station capable of communicating by a first wireless communication system, a plurality of first nodes capable of communicating by the first wireless communication system and a second wireless communication system, and a plurality of second nodes capable of communicating by the second wireless communication system, the first node being connected to the base station via another first node or directly by the first wireless communication system, and the second node being connected to the first node via another second node or directly by the second wireless communication system, in which the first node transmits the number of hops in the first wireless communication system to the second node, the second node obtains a reception condition of at least one of a signal transmitted by the first node and a signal transmitted by the second node, and selects a upper stage node to connect based on the number of hops in the first wireless communication system, the number of hops in the second wireless communication system, and the obtained reception condition information.

According to the embodiment of this invention, each of the nodes is connected hierarchically, so that a sensor can be placed in a wide range. Furthermore, since the number of hops is small, and a path under a satisfactory condition is selected autonomously, connection reliability is high, and the accuracy of data transmission is enhanced.

### BRIEF DESCRIPTION OF THE DRAWINGS

The present invention can be appreciated by the description which follows in conjunction with the following figures, wherein:

FIG. 1 is a diagram showing a configuration of a wireless communication system of an embodiment according to this invention;

FIG. 2 is a block diagram showing a configuration of a hub node in the embodiment according to this invention;

FIG. 3 is a block diagram showing a configuration of a sensor node in the embodiment according to this invention;

FIG. 4 is a sequence diagram at a time of construction of the wireless communication system of the embodiment according to this invention;

FIG. 5 is a diagram showing a configuration of a hello packet in the embodiment according to this invention;

FIG. 6 is a flow chart of hello packet reception processing in the embodiment according to this invention; and

FIG. 7 is a diagram showing a configuration of a constructed network.

### DETAILED DESCRIPTION OF THE PREFERRED EMBODIMENTS

Hereinafter, this invention will be described by way of an embodiment with reference to the drawings.

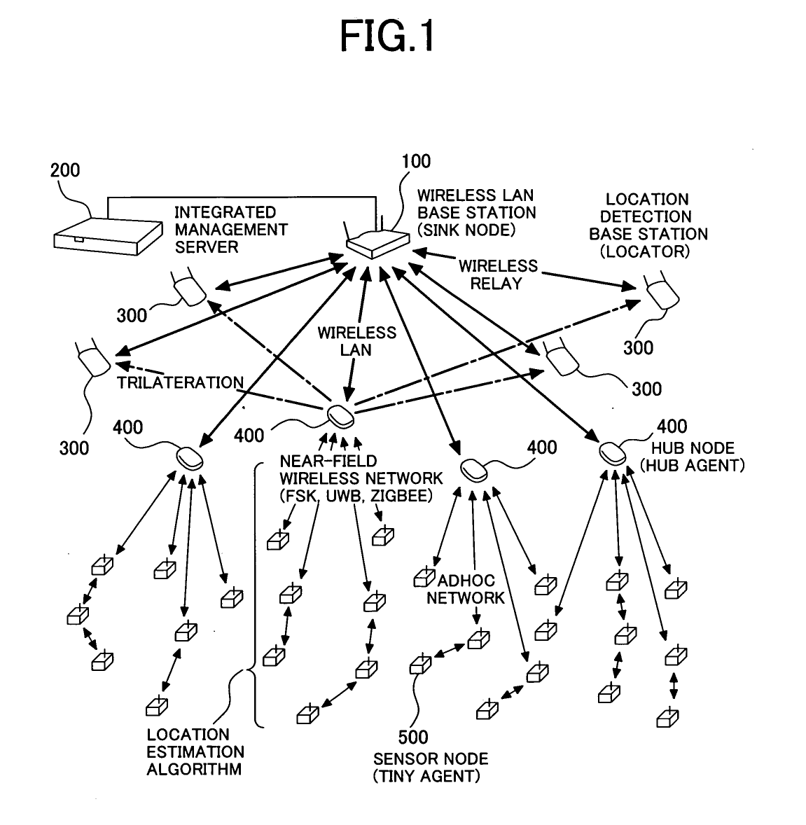

FIG. 1 is a diagram showing a configuration of a wireless communication system of the embodiment of this invention.

The wireless communication system of this embodiment comprises a wireless LAN base station 100 as a sink node, hub nodes 400 connected to the wireless LAN base station 100, location detecting base stations (locators) 300 received signals from the hub nodes 400 so as to calculate locations of the hub nodes 400, sensor nodes 500 connected to the hub nodes 400, and an integrated management server 200 integratively managing the wireless communication system.

The sink node 100 is provided on near to the hub nodes 400, and connected to the hub nodes 400 so as to communicate via wireless LAN network. Therefore, the sink node 100 has an antenna, a radio frequency unit, and a unit. A signal received by the antenna is input to the radio frequency baseband unit, converted into a baseband signal by amplification and frequency conversion, and input to the baseband unit. The baseband unit demodulates and decodes a baseband signal, and performs error-correction processing. The sink node 100 may be provided with a function of the location detecting base stations 300 described later so as to receive positioning signals transmitted from the hub nodes 400.

Furthermore, the sink node 100 has a network I/F unit, and is connected to the integrated management server 200 via the network.

The integrated management server 200 has a network I/F unit, and is connected to the sink node 100 via the network. Furthermore, the integrated management server 200 has a CPU and a memory, and manages the configuration of the wireless communication system. This configuration includes location information of the location detecting base stations 300, and connection information of the hub nodes 400 and the sensor nodes 500 connected hierarchically. Furthermore, the integrated management server 200 calculates locations of the hub nodes 400 based on the timings of signals received by the location detecting base stations 300. The integrated management server 200 also calculates locations of the sensor nodes 500 based on the analyses of signals from the sensor nodes 500 received by the hub nodes 400.

The location detecting base stations 300 are provided on near to the hub nodes 400, transmit signals for location detecting to the hub nodes 400, and/or receive signals for location detecting transmitted from the hub nodes 400. Therefore, each of the location detecting base stations 300 has an antenna, a radio frequency unit, a baseband unit, and a reception timing measurement unit. A signal received by the antenna is input to the radio frequency unit, converted into a baseband signal by amplification and frequency conversion, and input to the baseband unit. The baseband unit demodulates and decodes a baseband signal, and performs error-correction processing. The reception timing measurement unit analyzes a received positioning signal, and specifies information capable of identifying a receiving time of the positioning signal and the hub node 400 transmitting the positioning signal.

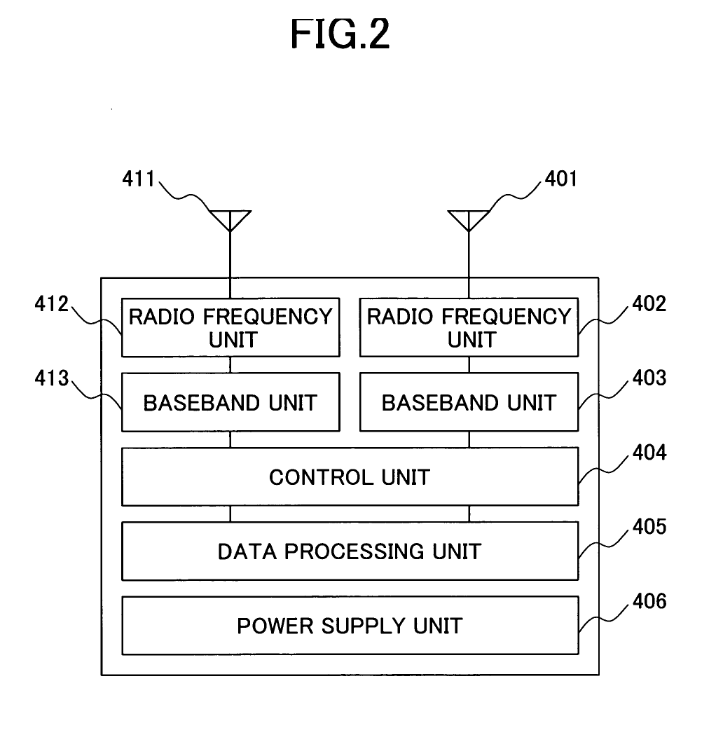

FIG. 2 is a block diagram showing a configuration of the hub node 400 in the embodiment of this invention.

The hub node 400 has an antenna 401, a first radio frequency unit 402, and a first baseband unit for first wireless system 403, and further has an antenna 411, a second radio frequency unit 412, and a second baseband unit for second wireless system 413, whereby the hub node 400 is configured so as to communicate with a plurality of kinds of different wireless communication systems. In this embodiment, the hub node 400 can communicate with the sink node (wireless LAN base station) 100 using a wireless LAN system as the first wireless system, and can communicate with the sensor node 500 using a near-field wireless system (e.g., FSK, UWB, ZigBee, etc.) as the second wireless system.

The data transmission distance of the first wireless system (wireless LAN system) is about 100 m, and the data transmission distance of the second wireless system (near-field wireless system) is about 10 m. The first wireless system has a data transmission distance longer than that of the second wireless system. Although the first wireless system and the second wireless system may have different data transmission distances in this manner, they may have different data transmission speeds (i.e., the first wireless system at a upper stage level has a higher data transmission speed).

Furthermore, a mobile telephone system or a traffic communication system (Intelligent Transport System) may be used as the first wireless system in place of the wireless LAN, and Bluetooth, UWB, or RFID may be used as the second wireless system. In other words, according to this invention, it is preferable that a public communication network or intracorporate communication network having a long communication distance be used as the first wireless system, and a P2P network, a sensor network, or a home network having a short communication distance be used as the second wireless system.

A control unit 404 comprises with a CPU and a memory, and controls an operation (e.g., sending and reception timings of data) of each unit of the hub node 400.

A data processing unit 405 comprises with a CPU and a memory, and performs data conversion processing of converting data received by one wireless system and generating data to be transmitted by the other wireless system. In the data conversion, received data is subjected to statistical processing, and data is transmitted by the other wireless system. More specifically, the data processing unit 405 performs compilation, averaging, variance calculation, filtering of extracting only data in a predetermined range, and statistical processing such as extraction of a maximum value with respect to data received by the second wireless system (near-field wireless system) from the sensor node 500, thereby converting the received data into data to be transmitted by the first wireless system (wireless LAN system). The data conversion is not statistical processing, and converts signal formats different between two wireless systems.

A power supply unit 406 supplies power to each unit of the hub node 400, and comprises with a secondary battery, a solar cell, a thermal power generation, electromagnetic power feeding, power generation based on a minute vibration, and the like. A power supply line connected to a commercial power supply is not necessary, so that there is no constraint to a setting place of the hub node 400.

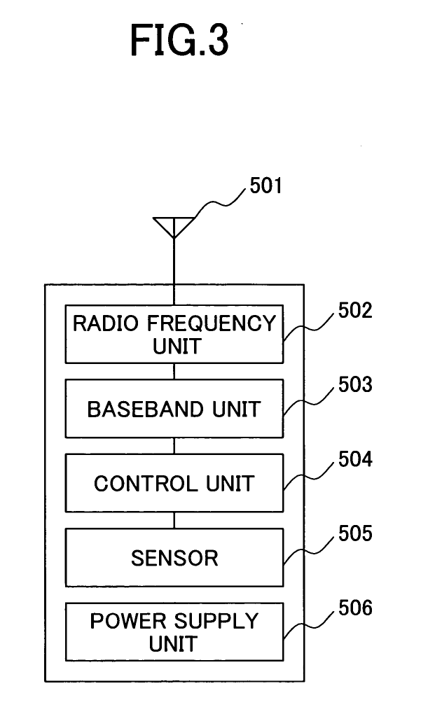

FIG. 3 is a block diagram showing a configuration of the sensor node 500 in this embodiment of this invention.

The sensor node 500 has an antenna 501, a radio frequency unit 502, a baseband unit 503, and a control unit 504 and is configured so as to communicate with the hub nodes 400 via a near-field wireless system (e.g., FSK, UWB, ZigBee, etc.).

A control unit 504 comprises with a CPU and a memory, and controls an operation (e.g., sending and reception timings of data) of each unit of the sensor node 500.

As a sensor 505, various sensors such as an optical sensor are provided depending upon the measurement objects detected by the sensor node 500. Any one of various kinds of sensors such as a humidity sensor, a thermal sensor (temperature sensor), a ultraviolet sensor, an infrared sensor, a radiation sensor, an electromagnetic sensor, an acceleration sensor, a distance sensor, a video sensor, a vibration sensor, a sound sensor, a magnetic sensor, a metal detection sensor, a molecular sensor, a chemical sensor, a biosensor, an odor sensor, and a taste sensor can be used as this sensor in addition to the above-mentioned kind of sensor.

A power supply unit 506 supplies power to each unit of the sensor node 500, and is composed of a secondary battery, a solar cell, a thermal power generation, wireless power feeding, power generation based on a minute vibration, and the like. A power supply line connected to a commercial power supply is not necessary, so that there is no constraint to a setting place of the sensor node 500.

Data obtained by the sensor 505 is supplied with location information of the sensor node 500. Then, the data is modulated by the baseband unit 503, subjected to frequency-conversion and amplification by the radio frequency unit 502, and transmitted using a near-field wireless system. The data obtained by the sensor 505 may be supplied with the location information of the sensor node 500 stored by the hub node 400 based on the address of the sensor node 500 in the hub node 400, without being supplied with the location information at the sensor node 500.

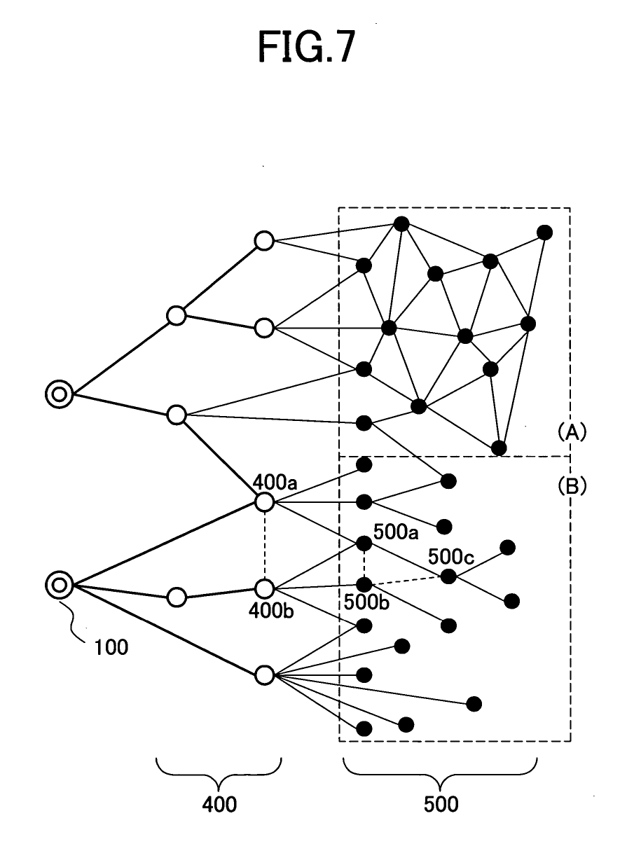

As shown in FIG. 1, in the wireless communication system of this embodiment, a hierarchical network is configured in the stage of the hub nodes 400 and the sensor nodes 500 with the sink node 100 being an apex. In other words, a plurality of the hub nodes 400 are connected to one sink node 100, and a plurality of the sensor nodes 500 are connected to one hub node 400. Furthermore, one sensor node 500 is connected to another sensor node 500. The hub node 400 may be connected directly to the sink node 100. However, as shown in FIG. 7, the hub node 400 may be connected to the sink node 100 via another hub node 400.

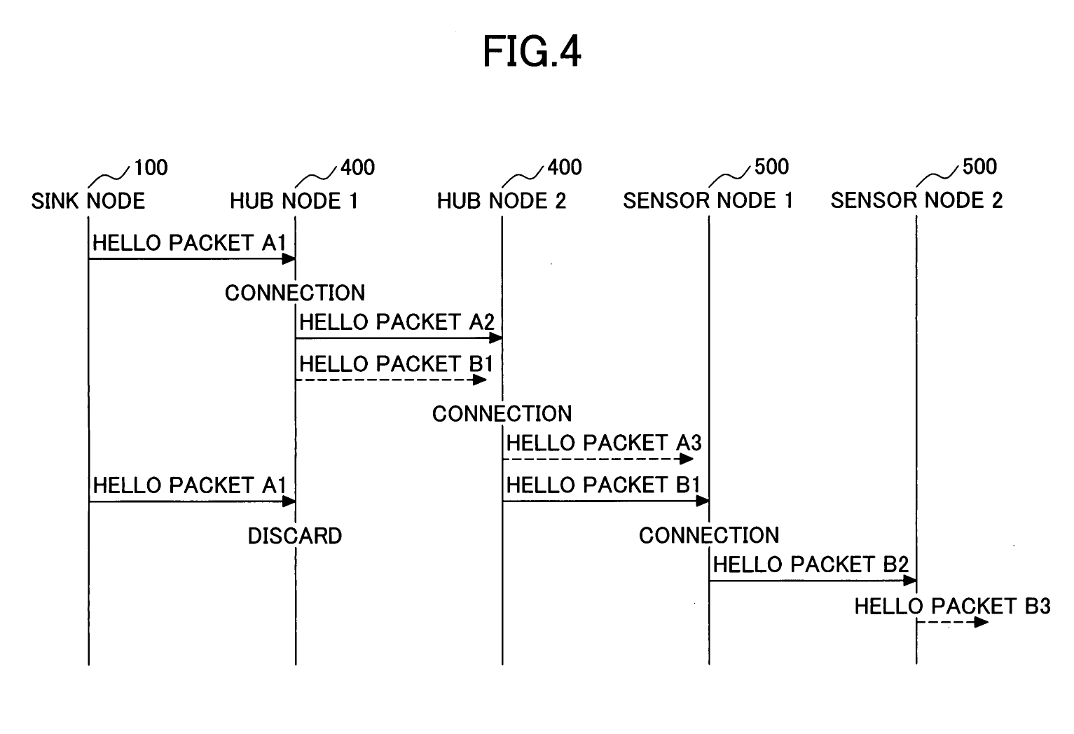

FIG. 4 is a sequence diagram at a time of construction of the wireless communication system of the embodiment of this invention.

The sink node 100 broadcasts a hello packet A1 (the hello packet A1 is a hello packet at a first level of a first wireless system) on a wireless LAN network at a predetermined timing (e.g., a predetermined time interval such as 30 seconds). The sink node 100 informs another node of the presence of the sink node 100 and that communication can be performed through the sink node 100, using the hello packet A1.

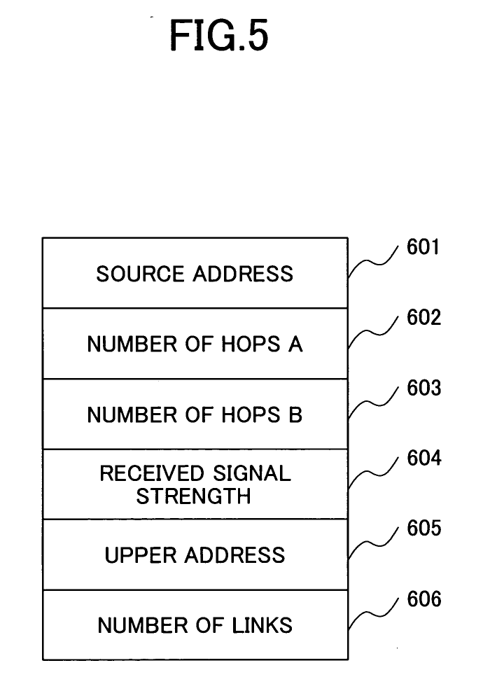

When the hub node 1 receives the hello packet A1 transmitted by the sink node 100, the hub node 1 is connected to the sink node 100, broadcasts a hello packet A2 (the hello packet A2 is a hello packet at a second level of the first wireless system) on the wireless LAN network. The hub node 1 informs another node of the presence of the hub node 1 and that communication can be performed through the hub node 1. The hello packet include information (number of hops) regarding at which level of the network the hub node 1 is positioned as shown in FIG. 5.

The hub node 1 can also communicate via a near-field wireless system, in addition to the wireless LAN system. Therefore, the hub node 1 broadcasts a hello packet B1 (hello packet at a first level of a second wireless system) even in the near-field wireless system, and informs another node of the presence of the hub node 1 and that communication can be performed through the hub node 1.

When the hub node 1 further receives the hello packet A1 transmitted by the sink node 100 after a connection to the sink node 100 has been established, since the connection to the node which transmits the hello packet A1 has already been established, the hub node 1 determines that the hello packet A1 is unnecessary and discards the received packet.

Furthermore, a hub node 2 having received the hello packet A2 transmitted by the hub node 1 is connected to the hub node 1, broadcasts a hello packet A3 (hello packet at a third level of the first wireless system) on the wireless LAN network, and informs another node of the presence of the hub node 2 and that communication can be performed through the hub node 2.

The hub node 2 can also communicate via a near-field wireless system, in addition to the wireless LAN system. Therefore, the hub node 2 broadcasts the hello packet B1 (hello packet at the first level of the second wireless system) even in the near-field wireless system, and informs another node of the presence of the hub node 2 and that communication can be performed through the hub node 2.

Furthermore, a sensor node 1 having received the hello packet B1 transmitted by the hub node 2 is connected to the hub node 2, broadcasts a hello packet B2 (hello packet at a second level of the second wireless system) in the near-field wireless system, and informs another node of the presence of the hub node 2 and that communication can be performed through the hub node 2.

Furthermore, a sensor node 2 having received the hello packet B2 transmitted by the sensor node 1 is connected to the sensor node 1, broadcasts a hello packet B3 (hello packet at a third level of the second wireless system) in the near-field wireless system, and informs another node of the presence of the sensor node 2 and that communication can be performed through the sensor node 2.

Thus, a node having completed a connection transmits a hello packet in a communication system in which a concerned station can communicate, whereby wireless stations are connected successively, and a hierarchical scale-free network as shown in (B) of FIG. 7 is constructed.

FIG. 5 is a diagram showing a configuration of a hello packet in the embodiment of this invention.

The hello packet includes a transmission source address 601, the number of hops A (602), the number of hops B (603), and received signal strength 604. The hello packet may further include a upper stage address 605 and the number of links 606.

The transmission source address 601 is information capable of identifying a node that transmits a concerned hello packet.

The number of hops is composed of the number of hops A (602) and the number of hops B (603), which respectively represent the number of hops between basic nodes in different wireless communication systems. In this embodiment, the sensor node 500 is connected to the sink node 100 through nodes by a upper stage wireless LAN system and a lower stage near-field wireless system. Thus, the number of hops A represents the number of hops at which connection is made through nodes between wireless LAN system intervals, and the number of hops B represents the number of hops at which connection is made through nodes between near-field wireless system intervals.

For example, the sensor node 1 shown in FIG. 4 has the number of hops of 2 in the wireless LAN system interval, and the number of hops of 1 in the near-field wireless system interval. Therefore, in the information stored in a hello packet transmitted by the sensor node 1, the number of hops A=2 and the number of hops B=1. Furthermore, the hub node 400 belonging to the upper stage network (wireless LAN) does not use a near-field wireless system for connection to a upper stage node. Therefore, the hub node 400 uses a hello packet having no section of the number of hops B, or a hello packet with the number of hops B=0.

The received signal strength 604 is information representing a signal strength at which a node having transmitted a concerned hello packet receives a signal (e.g., hello packet) from a upper stage node. The received signal strength 604 as received signal condition is not limited to a received signal strength indicator (RSSI), and a bit error rate (BER), a carrier interference ratio (CIR), a carrier noise ratio (C/N), a signal interference ratio (SIR), a signal noise ratio (S/N), and the like can be used.

The upper stage address 605 is information capable of identifying a upper stage node connected to a node to which a concerned hello packet is transmitted.

The number of links 606 is information representing the number of nodes connected to a node to which a concerned hello packet is transmitted. The number of links 606 may include information capable of specifying a connected node, instead of the information on the number of nodes connected to the node to which a concerned hello packet is transmitted.

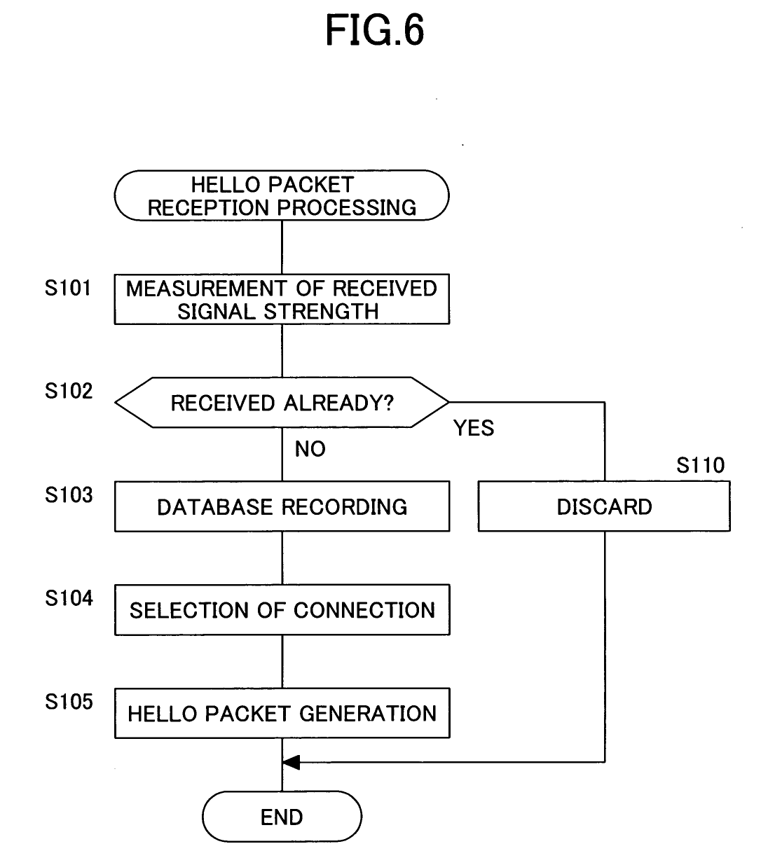

FIG. 6 is a flow chart of hello packet reception processing in the embodiment of this invention.

A node having received a hello packet measures received signal strength (S101). After that, the node extracts the transmission source address 601 from the received hello packet, and determines whether or not a hello packet having the same contents has already been received from the transmission source node, with reference to a database recording the hello packet (S102).

When the hello packet having the same contents has already been received, and the received packet has already been processed, the node determines that the hello packet is unnecessary and discards the received packet (S110).

On the other hand, when the node determines that the hello packet having the same contents has not been received, and the packet having same contents as the received packet has not been processed, the node will determine whether or not to make a connection concerned packet in later steps (S103 to S105).

First, the transmission source address 601, the numbers of hops 602, 603, the received signal strength 604 and the number of links 606 are extracted from the received hello packet, and are recorded in a database (S103).

After that, a connection target is selected (S104). In this connection selection processing, an appropriate connection target is selected using a predetermined function. For example, a hello packet recorded in the database is evaluated using a function F represented by an equation (1). In the equation (1), α and β represent weighing coefficients with respect to each number of hops. The coefficients α and β are previously determined based on the characteristics (communication speed, communication distance, communication cost) of the wireless LAN system and the near-field wireless system. The hub node 400 belonging to a upper stage network (wireless LAN) does not use a near-field wireless system for connection to a upper stage node, so that β=0 or the number of hops B=0.
F=α×number of hops A+β×number of hops B−received signal strength (1)

Then, a hello packet exhibiting a minimum function value F is obtained, and a node to which the hello packet exhibiting a minimum value is transmitted is selected as a connection target. Thus, a connection target is selected using the number of hops and a received signal strength in two levels, whereby an appropriate connection target can be selected.

In the selection of a connection, the number of nodes connected to the node to which the hello packet is transmitted may be considered. In this case, a hello packet is evaluated using a function G represented by an equation (2), using the number of links 606 in the hello packet.
G=α×number of hops A+β×number of hops B−received signal strength−γ×number of links (2)

A node having a small number of links may be preferentially connected using the function F instead of the function G.

Furthermore, a particular upper stage apparatus may be preferentially connected using the upper stage address 605.

The upper stage apparatus of the hub node 400 is the sink node 100 or another hub node. Therefore, even when a hello packet transmitted by the near-field wireless system is received, this hello packet is not evaluated.

A hello packet transmitted by a concerned station is generated (S105). In the hello packet generation processing, the address of the concerned station is written in the transmission source address 601. The transmission source address (address of the concerned station) may vary depending upon the wireless communication system. Furthermore, the information of the received signal strength measured when the hello packet is received from the upper stage node is written in the received signal strength information 604, the address of the upper stage node selected in the step S104 is written in the upper stage address 605, and the number of nodes connected to the concerned station is written in the number of links 606.

Furthermore, among the numbers of hop A and the numbers of hop B, one is added to the number of hops corresponding to the wireless communication system used for the connection to the selected upper stage node, whereby the number of hops 602 or 603 is updated.

FIG. 7 is a diagram showing a configuration of a constructed network in the embodiment of this invention.

As described above, according to this embodiment, a hierarchical scale-free network in which the hub nodes 400 and the sensor nodes 500 are successively connected with the sink node 100 being an apex is constructed. In FIG. 7, part (B) shows a scale-free network, and in FIG. 7, part (A) shows a random network. According to this embodiment, in order to configure the random network, the number of connection from one node is not limited to one, and one node is allowed to be connected to a plurality of nodes, whereby one node is connected to a plurality of nodes in the vicinity thereof to construct the random network.

Next, a method of measuring the location of the sensor node 500 of this invention will described.

In order to measure the location of the sensor node 500, the location of the hub node 400 to which the sensor node 500 is connected needs to be measured. The location of the hub node 400 is measured in the following manner, for example, as described in General Conference 2003 (A. Ogino et al “Study of Wireless LAN Integrated Access System (15) Location Detecting System”, Papers of General Conference 2003, B-5-203, p. 662, The Institute of Electronics, Information and Communication Engineers). The difference between times (Ti-T1 of reception timing of the respective base stations), at which the respective base stations (location detecting base stations 300) receive signals transmitted from the terminal, is calculated, the reception timing difference is multiplied by a light speed to calculate the difference in signal transmission distance between the terminal and the respective base stations by an equation (3), whereby the location of the terminal can be calculated. Herein, by using the signal transmitted from the base station and received by the terminal, the difference in propagation distance may be obtained from a reception timing of a transmission signal from each base station.
{|P−Pi|−|P−P1|}=c(Ti−T1),i=2, . . . , n (3)

Then, the hub nodes 400a and 400b whose locations have been measured receive a signal from the sensor node 500a whose location is not known, and transmit the received signal strength indicator (RSSI) to the integrated management server 200. The integrated management server 200 calculates a distance between the hub nodes that have received the signal and the sensor node 500a based on the received signal strength of the signal from the sensor node 500a, which a plurality of the hub nodes 400 have received. The distance between the hub nodes (reception point) 400 and the sensor node 500 can be obtained by the fact that the strength of the transmitted electric wave is inversely proportional to the square of the distance between the transmission/reception points.

By using the known distance between the hub nodes 400a and 400b, a triangle is formed of the hub nodes 400a and 400b whose locations are known and the sensor node 500a whose location is not known, and the location of the sensor node 500a is calculated by the principle of trilateration.

Then, in the same procedure, the sensor node 500a and the hub node 400b whose locations are known receive a signal from the sensor node 500b, and transmit the received signal strength indicator (RSSI) to the integrated management server 200. The integrated management server 200 calculates a distance between nodes based on the received signal strength. Then, a triangle is formed of the hub node 400b, the sensor node 500a and the sensor node 500b whose location is not known, whereby the location of the sensor node 500b is calculated.

Furthermore, the sensor node 500b and the sensor node 500a whose locations are known receive a signal from the sensor node 500c, and transmit the received signal strength indicator (RSSI) to the integrated management server 200. The integrated management server 200 calculates a distance between nodes based on the received signal strength. Then, a triangle is formed of the sensor node 500a, the sensor node 500b and the sensor node 500c whose location is not known, whereby the location of the sensor node 500c is calculated.

One hub node (reception point) 400 may receive a signal from the sensor node 500, instead that a plurality of hub nodes (reception points) 400 receive a signal from the sensor node 500, whereby the location of the hub node can be obtained. This is because the node connected to the sensor node 500 to be measured is assumed to be in a range of several meters, so that the direction in which the sensor node 500 is present can be assumed based on the network structure stored in the integrated management server 200.

Furthermore, in the above-mentioned description, the received signal strength of a signal from the sensor node whose location is not known is measured with the sensor node whose location is known. However, the received signal strength of a signal from the sensor node whose location is known is measured with the sensor node whose location is not known, and the measurements may be transmitted to the server via a upper stage node. A hello packet used for constructing the above-mentioned wireless communication system may be used as the signal for measuring the received signal strength. In this case, each sensor node measures the received signal strength of each received hello packet, and transmits the received signal strength of the hello packet to the server via a upper stage node selected as a connection target, together with the information specifying a transmission source node.

Furthermore, a location assuming method using the above-mentioned network structure and a location measuring method based on a received signal strength may be used together.

As described above, in the embodiment of this invention, a upper stage level (server side) of the network is connected by the wireless LAN system, and a lower stage level (terminal side) is connected by the near-field wireless system. Therefore, the data transmission distance from the sensor node can be increased, and a sensor can be disposed in a wide range.

Furthermore, a node autonomously selects a path having a small number of hops and a satisfactory communication state, so that a network can be constructed easily. Furthermore, even when a trouble occurs in a part of the network, the node autonomously selects another path, so that resistance to failure can be enhanced. Furthermore, the node autonomously selects a path having a small number of hops and a satisfactory communication state, so that high connection reliability can be maintained and the accuracy of data transmission can be enhanced.

This invention can be applied to an anti-disaster system that detect an earthquake, a landslide, an avalanche, a volcanic activity, etc., a river monitoring system, a road monitoring system, and a railroad monitoring system with a sensor node. This invention can also be applied to a building management system and a home management system that detect temperature/humidity, a brightness, noise, and the like with a sensor node to control an air condition, illumination, and various kinds of equipment (electric appliance) based on the presence information and characteristics of an individual, a terminal position, and the like.

Furthermore, this invention can be applied to an environment information system for monitoring the environment information (e.g. place, behavior, etc.) of a human with a sensor node, and a contextware system. Furthermore, this invention can be applied to a medical system for monitoring the condition of a patient with a sensor node to control medical equipment.

Furthermore, this invention can be applied to a management system of a fire station, a police station, and the military for detecting the positions and biological information of members with a sensor node to manage the behavior of the members. This invention can also be applied to a land mine restraint system for detecting metal with a sensor node.

This invention also includes the following aspect.

A method of constituting a wireless communication system comprising a wireless base station capable of communicating by a first wireless communication system, a plurality of first nodes capable of communicating by the first wireless communication system and a second wireless communication system, and a plurality of second nodes capable of communicating by the second wireless communication system, the first node being connected to the wireless base station via another first node or directly by the first wireless communication system, and the second node being connected to the first node via another second node or directly by the second wireless communication system, whereby each of the nodes is connected hierarchically, wherein the first node transmits the number of hops in the first wireless communication system to the second node, the second node obtains a reception condition of at least one of a signal transmitted by the first node and a signal transmitted by the second node, and selects a upper stage node to be a connection target based on the number of hops in the first wireless communication system, the number of hops in the second wireless communication system, and the obtained reception condition information.

In addition, the first node transmits transmission source information specifying the first node, the number of hops in the first wireless communication system, reception condition information on a signal received by the first node, upper stage apparatus information specifying a upper stage node to which the first node is connected or a wireless base station, and information on a node connected to the first node.

In addition, the second node transmits transmission source information specifying the second node, the number of hops in the first wireless communication system, the number of hops in the second wireless communication system, reception condition information on a signal received by the second node, upper stage apparatus information specifying a upper stage node to which the second node is connected, and information on a node connected to the second node.

Another aspect of this invention is a method of measuring a location of a node in a wireless communication system comprising a wireless base station capable of communicating by a first wireless communication system, a plurality of first nodes capable of communicating by the first wireless communication system and a second wireless communication system, a plurality of second nodes capable of communicating by the second wireless communication system, a plurality of location detecting base stations for communicating with the first nodes, and a server for calculating positions of the first nodes and/or the second nodes. The first node is connected to the wireless base station directly or via another first node by the first wireless communication system, and transmits the number of hops in the first wireless communication system to the second node. The second node obtains reception states of a signal transmitted by the first node and a signal transmitted by the second node, selects a upper stage node to be a connection target based on the number of hops in the first wireless communication system, the number of hops in the second wireless communication system, and the obtained reception state information, and is connected to the first node directly or via another second node by the second wireless communication system. The server receives reception timing information on a signal transferred between the first node and the location detecting base station, calculates a location of the first node using the difference in reception timing information among the plurality of location detecting base stations, receives received signal strength of a signal transferred between the first node and the second node, and calculates a distance between a reception point of the signal from the second node and the second node, using the received signal strength, thereby calculating a location of the second node.

While the present invention has been described in detail and pictorially in the accompanying drawings, the present invention is not limited to such detail but covers various obvious modifications and equivalent arrangements, which fall within the purview of the appended claims.

1. A wireless communication system comprising a wireless base station, a plurality of first nodes, and a plurality of second nodes, wherein:
the base station communicates by a first wireless communication system;
the first node communicates to the base station and another first node by the first wireless communication system, communicates to the second node by a second wireless communication system, is connected to the wireless base station directly or via another first node by the first wireless communication system, and transmits the number of hops in the first wireless communication system to the second node; and
the second node is connected to the first node directly or via another second node by the second wireless communication system, obtains a reception state of at least one of a signal transmitted by the first node and a signal transmitted by the second node, and selects a upper stage node to be connected to based on the number of hops in the first wireless communication system, the number of hops in the second wireless communication system, and the obtained reception state information.

2. The wireless communication system according to claim 1, wherein the first node transmits transmission source information specifying the first node, the number of hops in the first wireless communication system, reception condition information on a signal received by the first node, upper stage apparatus information specifying a upper stage node to which the first node is connected and a base station, and information on a node connected to the first node.

3. The wireless communication system according to claim 1, wherein the second node transmits transmission source information specifying the second node, the number of hops in the first wireless communication system, the number of hops in the second wireless communication system, reception condition information on a signal received by the second node, upper stage apparatus information specifying a upper stage node to which the second node is connected, and information on a node connected to the second node.

4. The wireless communication system according to claim 1, comprising a location detecting base station, and a positioning server calculating a location of at least one of the first node and the second node, wherein:
the first node transmits, to the positioning server, information on a received signal strength of a signal transmitted from the second node to the first node; and
the positioning server calculates a location of the first node based on a reception timing of a signal transferred between the first node and the location detecting base station, and a distance between a reception point of the signal and the second node using the received signal strength information to calculate a location of the second node.

5. A wireless node, comprising a first radio frequency unit, a second radio frequency unit, a packet generating unit, and a connection selecting unit, wherein:
a first radio frequency unit communicates with a first node by a first wireless communication system, communicates with a base station directly or via the first node by the first wireless communication system, and obtains a reception condition of at least one of a signal transmitted by the first node and a signal transmitted by the base station;
a second radio frequency unit communicates with a second node directly or via another second node by a second wireless communication system;
a packet generating unit generates a packet containing transmission source information specifying the wireless node, the number of hops in the first wireless communication system, reception condition information of a signal received by the wireless node, upper stage apparatus information specifying a upper stage node to which the wireless node is connected and a base station, and information on a node connected to the wireless node; and
a connection selecting unit selects a connection with respect to the network, selects a upper stage apparatus to connect to based on the number of hops in the first wireless communication system, and the obtained reception condition information.

6. A wireless node comprising a radio frequency unit, a packet generating unit, and a connection selecting unit, wherein:
a radio frequency unit communicates, by a second wireless communication system, with a communication apparatus that communicates with a upper stage apparatus by a first wireless communication system, communicates with the first node directly or via another second node by the second wireless communication system, and obtains a reception condition of at least one of a signal transmitted by the second node and a signal transmitted by the first node;
a packet generating unit generates a packet containing transmission source information specifying the wireless node, the number of hops in the first wireless communication system, the number of hops in the second wireless communication system, reception condition information of a signal received by the wireless node, upper stage apparatus information specifying a upper stage node to which the wireless node is connected, and information on a node connected to the wireless node; and
a connection selecting unit for selecting a connection with respect to the network, selects a upper stage node to connect to based on the number of hops in the first wireless communication system, the number of hops in the second wireless communication system, and the obtained reception condition information.
